(19) United States
(12) Patent Application Publication
(10) Pub. No.: US 2007/0164013 A1
(43) Pub. Date: Jul. 19, 2007

(54) Device to heat up and keep tortillas or bread warm

(76) Inventor: David Larrabure Reyes, Mexico (MX)

Correspondence Address: David Larrabure Reyes;Centro Comercial Interlomas Local, 1041 Boulevard Interlomas No 5, Huixquilucan, 52786, MX

(21) Appl. No.: 10/575,010

(22) PCT Filed: Oct. 8, 2004
(86) PCT No.: PCT/MX04/00072

§ 371 Date: Feb. 28, 2007

(30) Foreign Application Priority Data
Oct. 10, 2003 (MX) PA/U/2003/000248

(51) Int. Cl. F27D 11/00

(52) U.S. Cl. 219/385; 219/387

(57) ABSTRACT

This invention refers to a new idea, a novel way to heat up and/or keep food warm; consisting of a self-heatable tortilla holder with an internal reusable source of heat.

### BACKGROUND OF THE INVENTION

Currently, there are some ways of keeping the tortillas or bread warm for a given time or any other thing that requires to be kept warm, these are known as ‘tortilla holders’, which are usually made of materials such as: plastic containers, woven with a natural fiber, such as osier or straw, which are like a small basket with a lid or the type of bags manufactured with different fabrics or synthetic material, within which the tortillas or the bread previously heated up are kept.

But none of these methods to heat up tortillas or bread has an internal source of heat such as the one in my invention, which operates fully self-sufficiently.

It does neither require any pre-heating, nor the use of batteries or electric power and is reusable.

### DESCRIPTION OF THE INVENTION

The details of this novel tortilla holder to heat up and (or keep food warm are clearly shown in the following description, with the relevant illustration, following the same reference signs to specify the parts and figures shown, where:

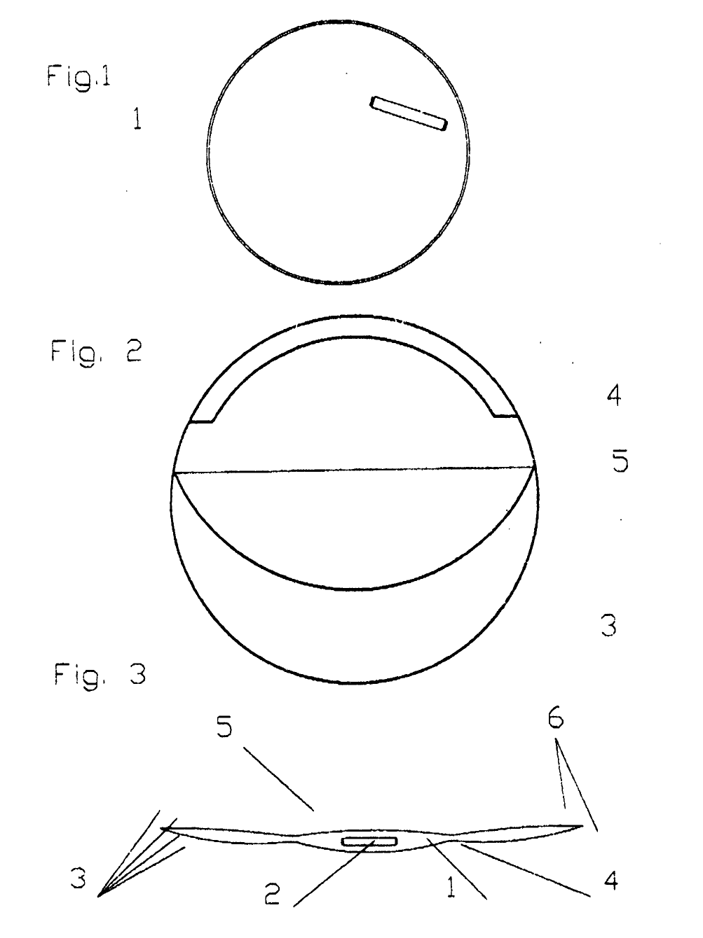

FIG. 1. Top view of the element described as HEATER (1).

FIG. 2. Top view of the THERMAL BAG (3).

FIG. 3. Cutaway view of the THERMAL BAG (3) with the HEATER (1) inside it.

Regarding these figures, the food heater is composed of a reusable device to heat up and/or keep food warm, which includes in a combined way: (a) a HEATER (1) device, which may be used more than once; b) a containing THERMAL BAG (3), which consists of a first wall and a second wall joined by their outer boundary, so that they define a bag with an entry; a middle wall, joined to and placed between the first and second wall, so that a first compartment (5), where the food to be heated will be placed, and a second compartment (4), where the removable HEATER (1) device will be placed, are defined.

The HEATER (1) device consists of a sealed plastic bag, full of liquid and a TRIGGER (2) immersed in the liquid, which operates to make the device start heating, after such TRIGGER (2) has been actuated by a user, which may be like a small spring covered with a cylindrical plastic sheath or may have the shape of a small metallic disc. When this TRIGGER (2) is pressed and an attempt is made to bend it, a reaction is leashed in the liquid contained in the HEATER (1), the liquid is at room temperature (cold) and begins to heat up and gradually passes to the solid state. Next, to reuse this HEATER (1), it has to be placed within a container with boiling water and let it simmer for approximately 10 minutes until it goes back fully to the liquid state and then it is ready to be reused.

After the heating process has restarted in the HEATER (1), it is placed inside the second compartment (4) of the THERMAL BAG (3), which is composed of an isolating fiber (6) to retain the heat that is being emitted from the HEATER (1), in this way, everything that is placed inside the first compartment (5) of the THERMAL BAG (3) will be heated and kept warm for a while. Nevertheless, any other device or container (thermal bag) may be used to heat up liquid and, also, food, as may be easily understood by experts in the field.

After having sufficiently described this invention, I consider it as a novelty, therefore, I claim of my exclusive ownership, the contents of the following clauses:

1. A reusable device to heat up and/or keep food warm, characterized because in a combined way it consists of: a) a HEATER (1) device, which may be used more than once;
b) a containing THERMAL BAG (3), which includes a first wall and a second wall joined by their outer boundaries, so that they define a bag with one entry; a middle wall joined to and placed between the first and second wall, so that a first compartment (5) where the food to be heated will be placed and a second compartment (4) where the removable HEATER (1) device will be placed are defined.

2. A reusable device to heat up and/or keep food warm as claimed in clause 1, characterized as well because the first and second walls are made of an isolating fiber (6)

3. A reusable device to heat up and/or keep food warm as claimed in clause 1, characterized because the HEATER (1) device consists of a sealed plastic bag, full of liquid and a TRIGGER (2) immersed in liquid, which operates to make the device start heating, after such TRIGGER (2) has been actuated by a user.
